(19) United States
(12) Patent Application Publication
(10) Pub. No.: US 2004/0254817 A1
(43) Pub. Date: Dec. 16, 2004

(54) System, method, and program for personal information reference, information processing apparatus and information management method

(75) Inventor: Yasuo Uzura, Osaka (JP)

Correspondence Address: McDERMOTT, WILL & EMERY, 600 13th Street, N.W., Washington, DC, 20005-3096, US

(73) Assignee: SANYO ELECTRIC CO., LTD.

(21) Appl. No.: 10/864,462

(22) Filed: Jun. 10, 2004

(30) Foreign Application Priority Data
Jun. 11, 2003 (JP) 2003-165871

(51) Int. Cl. G06F 17/60

(52) U.S. Cl. 705/2

(57) ABSTRACT

A user terminal reads a personal recognition ID and preprogramming information from a memory unit to generate program data. The user terminal, when an owner password is input to an owner input area on an input screen, transmits an owner personal recognition ID, the owner password, and program data to a server, and when a third party personal recognition ID and a third party password are input to a third party input area, transmits the owner personal recognition ID, the third party personal recognition ID, the third party password, and program data to the server.

### BACKGROUND OF THE INVENTION

1. Field of the Invention

The present invention relates to a system, method, and program for personal information reference, an information processing apparatus and an information management method.

2. Description of the Background Art

In the medical field, a basic structure is established in which a doctor strictly manages and stores for treatment a variety of clinical related data, such as results of patient physical examinations, to protect patient privacy. For this reason, under the data management system in a medical institution such as a hospital, only the permitted persons have access to a specific database from a computer terminal under network environment.

In order to improve security for such data management, various types of systems and methods have been proposed.

For example, multiple authentication methods using an electronic device with an USB (Universal Serial bus) interface have been proposed (refer to JP 2002-312326 A, for example) In the multiple authentication methods, access to computers, a variety of devices, databases and the like is controlled by utilizing the USB key.

Further, a key authentication apparatus for computer which utilizes a USB key has been proposed (refer to JP 2002-251226 A, for example). In the key authentication apparatus, the USB key is used for the authentication in utilizing a notebook computer and the like.

On the other hand, a system for personal information management has been proposed which improves security for access to a database related to user's personal information such as clinical information (refer to JP 2002-149814 A, for example). Further, a health care system has been proposed which helps to provide adequate first aid in a short period by providing access to the heath data of health care service users also from medical institutions other than the medical institution of the attending doctor, while security is being ensured (refer to JP 2003-67502 A, for example).

As described above, data management systems which provide access to patient data from only permitted persons have been constructed for the protection of patient privacy.

On the other hand, with high respect recently being paid to a preventive medicine point of view, comprehensive healthcare or health reinforcement practice has been proposed from multiple aspects, not only from medical treatment but also from nutritional therapy, exercise therapy, and mental therapy aspects. In the field of such healthcare, a variety of health care staff, such as a dietitian, fitness instructor, physical therapist, and clinical psychotherapist as well as a doctor are required to provide instructions and advice based on the health related data of an individual.

The health related staff, however, are not necessarily located at one place, nor do they belong to the identical organization. Patients hope to readily receive instructions and advice based on the individual's health related data from appropriate health related staff, at any time, any place.

Meanwhile, because of an individual privacy aspect which patient health related data has, even the health related staff should not be allowed free access to the health related data of a patient without the patient permission.

Therefore, it is difficult for the health related staff to access the health related data of an individual in accordance with the individual's will to provide instructions or advice based on the individual's health related data.

### SUMMARY OF THE INVENTION

An object of the present invention is to provide a system for personal information reference, a method for personal information reference, a program for personal information reference, and an information processing apparatus which allow a third party permitted by an owner to refer to specific personal information readily and safely, while security for the personal information is being ensured.

Another object of the present invention is to provide an information management method by which a member is permitted to refer to specific information while security for the information is being ensured.

A system for personal information reference according to one aspect of the present invention comprises: a host computer that manages personal information; a terminal capable of communicating with the host computer; and a recording medium portable and connectable with the terminal, wherein the recording medium records identification information for identifying an owner of the recording medium and program information indicative of a method for processing data, the terminal transmits the identification information of the owner recorded in the recording medium and data generated based on the program information to the host computer when connected with the recording medium, and the host computer determines permission/rejection for/of reference to the personal information from the terminal based on the identification data of the owner and the data received from the terminal.

In the system for personal information reference, the personal information is managed by the host computer. The identification information for identifying an owner of the recording medium, and the program information indicative of a method for processing data are recorded in the recording medium. When the terminal is connected with the recording medium, the identification information of the owner recorded in the recording medium and the data generated based on the program information are transmitted to the host computer. The host computer determines permission/rejection for/of reference to the personal information from the terminal based on the identification of the owner and data received from the terminal. This ensures security for the personal information of the owner.

In this case, the owner of the recording medium lends his/her recording medium to a third party, so that the third party is allowed to refer to the personal information of the owner. Consequently, the third party permitted by the owner can refer to the personal information of the owner readily and safely, while security for the personal information is being ensured.

The terminal may have an owner input section that receives input of authentication information for authenticating the owner of the recording medium; when the terminal is connected with the recording medium, and the authentication information of the owner is input to the owner input section, the terminal may transmit the identification information of the owner recorded in the recording medium and the data generated based on the program information along with the authentication information of the owner to the host computer; and the host computer may determine permission/rejection for/of reference to the personal information from the terminal based on the identification information of the owner, the data, and the authentication information of the owner received from the terminal.

In this case, when the terminal is connected with the recording medium, and the authentication information of the owner is input to the owner input section, the identification information of the owner recorded in the recording medium, data generated based on the program information, and authentication information of the owner are transmitted from the terminal to the host computer. Based on the identification information of the owner, data, and authentication information of the owner received from the terminal, it is determined by the host computer whether the reference to the personal information from the terminal is permitted or rejected.

This allows the owner to refer to his/her own personal information readily and safely, while security for the owner personal information is being ensured.

The host computer may have a third party permitted to refer to the personal information registered; the terminal may have a third party input section that receives input of authentication information for authenticating the registered third party; when the terminal is connected with the recording medium, and the authentication information of the third party is input to the third party input section, the terminal may transmit the identification information of the owner recorded in the recording medium and the data generated based on the program information along with the authentication information of the third party to the host computer; and the host computer may determine permission/rejection for/of reference to the personal information from the terminal based on the identification information of the owner, the data, and the authentication information of the third party received from the terminal.

In this case, when the terminal is connected with the recording medium, and the authentication information of the third party is input to the third party input section, the identification information of the owner recorded in the recording medium, data generated based on the program information, and authentication information of the third party are transmitted from the terminal to the host computer. Based on the identification information of the owner, data, and authentication information of the third party received from the terminal, it is determined by the host computer whether the reference to the personal information from the terminal is permitted or rejected.

This allows the third party permitted by the owner to refer to the personal information of the owner readily and safely, while security for the owner personal information is being ensured.

The third party input section may further be capable of receiving input of identification information for identifying the registered third party; when the terminal is connected with the recording medium, and the authentication information of the third party and the identification information of the third party are input to the third party input section, the terminal may transmit the identification information of the owner recorded in the recording medium and the data generated based on the program information along with the authentication information of the third party and the identification information of the third party to the host computer; and the host computer may determine permission/rejection for/of reference to the personal information from the terminal based on the identification information of the owner, the data, the authentication information of the third party, and the identification information of the third party received from the terminal.

In this case, when the terminal is connected with the recording medium, and the authentication information of the third party and identification information of the third party are input to the third party input section, the identification information of the owner recorded in the recording medium, data generated based on the program information, authentication information of the third party, and identification information of the third party are transmitted from the terminal to the host computer. Based on the identification information of the owner, data, authentication information of the third party, and identification information of the third party received from the terminal, it is determined by the host computer whether the reference to the personal information from the terminal is permitted or rejected.

This allows the third party permitted by the owner to refer to the personal information of the owner readily and more safely, while security for the owner personal information is being ensured.

The host computer may include a preset item of personal information which can be referred to by the third party, and the host computer may permit reference to the preset item of personal information by the third party when determining that the identification information of the owner, the data, and the authentication information of the third party received from the terminal are valid.

In this case, the host computer permits the third party to refer to the set item of personal information, when determining that the identification information of the owner, data, and authentication information of the third party received from the terminal are valid.

This allows the third party permitted by the owner to refer to the preset item of personal information of the owner readily and safely, while security for the owner personal information is being ensured.

A method for personal information reference according to another aspect of the present invention uses a host computer that manages personal information, a terminal capable of communicating with the host computer, and a recording medium portable and connectable with the terminal and comprises the steps of: recording identification information for identifying an owner of the recording medium and program information indicative of a method for processing data into the recording medium; transmitting, when the terminal is connected with the recording medium, the identification information of the owner recorded in the recording medium and data generated based on the program information to the host computer; and determining by the host computer permission/rejection for/of reference to the personal information from the terminal based on the identification information of the owner and the data received from the terminal.

In the method for personal information reference, the identification information for identifying an owner of the recording medium and the program information indicative of a method for processing data are recorded in the recording medium. When the terminal is connected with the recording medium, the identification information of the owner recorded in the recording medium and the data generated based on the program information are transmitted to the host computer. Based on the identification information of the owner and data received from the terminal, it is determined by the host computer whether the reference to the personal information from the terminal is permitted or rejected.

In this case, the owner of the recording medium lends his/her recording medium to a third party, so that the third party can refer to the personal information of the owner. Consequently, the third party permitted by the owner can refer to the personal information of the owner readily and safely, while security for the owner personal information is being ensured.

A program for personal information reference according to still another aspect of the present invention is executable by a terminal capable of communicating with a host computer that manages personal information and connectable with a recording medium, and allows the terminal to execute the processes of: reading from the recording medium identification information for identifying an owner of the recording medium and program information indicative of a method for processing data recorded in the recording medium; receiving input of authentication information for authenticating the owner of the recording medium; receiving input of authentication information for authenticating a third party different from the owner of the recording medium; transmitting, when the authentication information of the owner is input, the identification information of the owner and the data generated based on the program information along with the authentication information of the owner to the host computer; and transmitting, when the authentication information of the third party is input, the identification information of the owner and the data generated based on the program information along with the authentication information of the third party to the host computer.

In the program for personal information reference, the identification information of the owner of the recording medium and the program information recorded in the recording medium are read from the recording medium, and input of the authentication information of the owner and authentication information of the third party is received. When the authentication information of the owner is input, the identification information of the owner, data generated based on the program information, and authentication information of the owner are transmitted to the host computer. When the authentication information of the third party is input, the identification information of the owner, data generated based on the program information, and authentication information of the third party are transmitted to the host computer. When receiving the identification information of the owner, data, and authentication information of the owner from the terminal, the host computer determines permission/rejection for/of reference to the personal information by the owner using the terminal, based on the received identification information of the owner, data, and authentication information of the owner.

The host computer can also determine, when receiving the identification information of the owner, data, and authentication of the third party from the terminal, permission/rejection for/of reference to the personal information by the third party using the terminal, based on the identification information of the owner, data, and authentication information of the third party.

This allows the third party permitted by the owner to refer to the personal information of the owner readily and more safely, while security for the owner personal information is being ensured.

A program for personal information reference according to yet another aspect of the present invention is executable by a host computer capable of communicating with a terminal and allows the host computer to execute the processes of: registering a member; storing personal information of the member; registering a third party who can refer to a preset item of the personal information; permitting the terminal to refer to the personal information of the member when receiving identification information of the registered member and authentication information for authenticating the registered member from the terminal; and permitting the terminal to refer to the preset item of the personal information of the member when receiving the identification information of the registered member and authentication information for authenticating the registered third party from the terminal.

In the program for personal information reference, a member is registered, and the personal information of the member is stored, in the host computer. The third party who can refer to the preset item of the personal information is also registered. When the identification information of the registered member and authentication information for authenticating the registered member are received from the terminal, the terminal is permitted to refer to the personal information of the member. When the identification information of the registered member and authentication information for authenticating the registered third party are received from the terminal, the terminal is permitted to refer to the preset item of the personal information of the member.

This allows the third party permitted by the owner to refer to the personal information of the owner readily and safely, while security for the owner personal information is being ensured.

An information processing apparatus according to still another aspect of the present invention is connectable with a recording medium for recording information, and comprises: a connector connected with the recording medium; and a display that displays an owner authentication information input area for inputting owner authentication information for authenticating an owner of the recording medium and a third party authentication information input area for inputting third party authentication information for authenticating a third party.

In the information processing apparatus, the connector is connected with the recording medium. Further, the owner authentication information input area for inputting the owner authentication information and the third party authentication information input area for inputting the third party authentication information are displayed on the display.

This allows the owner of the recording medium to input the owner authentication information to the owner authentication information input area. The third party can also input the third party authentication information to the third party authentication information input area.

As a result, it is possible for the third party permitted by the owner to refer to the personal information of the owner readily and safely, while security for the owner personal information is being ensured.

The recording medium may record identification information for identifying the owner, and the display may further have: an owner identification information display area for displaying the identification information of the owner recorded in the recording medium; and a third party identification information input area for inputting identification information for identifying the third party.

In this case, the identification information for identifying an owner is recorded in the recording medium. Further, the identification information of the owner recorded in the recording medium is displayed on the owner identification information display area. This allows the owner of the recording medium to verify readily the identification information of the owner recorded in the recording medium. The third party can also input the identification information of the third party to the third party identification information input area. This allows the third party permitted by the owner to refer to the personal information of the owner readily and safely, while security for the owner personal information is being ensured.

An information management method according to yet another aspect of the present invention comprises the steps of: storing information including one or more items into a first storage of a computer system; registering a member permitted to refer to the information stored in the first storage and an item which can be referred to by the member into a second storage of the computer system; and updating contents of the registration in the second storage by a processing unit of the computer system.

In the information management method, the information including one or more items is stored in the first storage of the computer system. Additionally, the member permitted to refer to the information stored in the first storage and the item which can be referred to by the member are recorded in the second storage of the computer system. Further, the contents of the registration are updated by the processing unit of the computer system.

Consequently, the registered member is permitted to refer to the registered item, while security for the information is being ensured.

The computer system may be arranged to communicate with a terminal connectable with a recording medium that stores identification information, and the method may further comprise the step of determining by the processing unit of the computer system permission/rejection for/of reference to the information stored in the first storage from the terminal based on the contents of registration in the second storage, when the computer system has received the identification information recorded in the recording medium from the terminal.

In this case, when the member has connected the recording medium to the terminal, the identification information recorded in the recording medium is transmitted to the computer system. When receiving the identification information recorded in the recording medium from the terminal, the computer system determines permission/rejection for/of reference to the information stored in the first storage from the terminal, based on the contents of registration in the second storage.

This allows the owner or third party to refer to the information readily and more safely using the recording medium, while security for the information is being ensured.

A system for personal information reference according to still another aspect of the present invention comprises: a host computer that manages personal information; a terminal capable of communicating with the host computer; and a recording medium portable and connectable with the terminal, wherein the recording medium records identification information for identifying an owner of the recording medium and predetermined data, the terminal transmits the identification information of the owner and predetermined data recorded in the recording medium to the host computer when connected with the recording medium, and the host computer determines permission/rejection for/of reference to the personal information from the terminal based on the identification data of the owner and the predetermined data received from the terminal.

In the system for personal information reference, the personal information is managed by the host computer. The identification information for identifying an owner of the recording medium and the predetermined data are recorded in the recording medium. When the terminal is connected with the recording medium, the identification information of the owner and predetermined data recorded in the recording medium are transmitted to the host computer. Based on the identification information of the owner and predetermined data received from the terminal, it is determined by the host computer whether the reference to the personal information from the terminal is permitted or rejected. This ensures security for the personal information of the owner.

In this case, the owner of the recording medium lends his/her recording medium to a third party, so that the third party can refer to the personal information of the owner. Consequently, it is possible for the third party permitted by the owner to refer to the personal information of the owner readily and safely, while security for the personal information is being ensured.

A method for personal information reference according to yet another aspect of the present invention uses a host computer that manages personal information, a terminal capable of communicating with the host computer, and a recording medium portable and connectable with the terminal and comprises the steps of: recording identification information for identifying an owner of the recording medium and predetermined data into the recording medium; transmitting, when the terminal is connected with the recording medium, the identification information of the owner and predetermined data recorded in the recording medium to the host computer; and determining by the host computer permission/rejection for/of reference to the personal information from the terminal based on the identification information of the owner and the predetermined data received from the terminal.

In the method for personal information reference, the identification information for identifying an owner of the recording medium and predetermined data are recorded in the recording medium. When the terminal is connected with the recording medium, the identification information of the owner and predetermined data recorded in the recording medium are transmitted to the host computer. Based on the identification information of the owner and data received from the terminal, it is determined by the host computer whether the reference to the personal information from the terminal is permitted or rejected.

In this case, the owner of the recording medium lends his/her recording medium to a third party, so that the third party can refer to the personal information of the owner. Consequently, it is possible for the third party permitted by the owner to refer to the personal information of the owner readily and safely, while security for the owner personal information is being ensured.

A program for personal information reference according to still another aspect of the present invention is executable by a terminal capable of communicating with a host computer that manages personal information and connectable with a recording medium, and allows the terminal to execute the processes of: reading from the recording medium identification information for identifying an owner of the recording medium and predetermined data recorded in the recording medium; receiving input of authentication information for authenticating the owner of the recording medium; receiving input of authentication information for authenticating a third party different from the owner of the recording medium; transmitting, when the authentication information of the owner is input, the identification information of the owner and the predetermined data along with the authentication information of the owner to the host computer; and transmitting, when the authentication information of the third party is input, the identification information of the owner and the predetermined data along with the authentication information of the third party to the host computer.

In the program for personal information reference, the identification information of the owner of the recording medium and predetermined data recorded in the recording medium are read from the recording medium, and input of the authentication information of the owner and authentication information of the third party is received. When the authentication information of the owner is input, the identification information of the owner, predetermined data, and authentication information of the owner are transmitted to the host computer. When the authentication information of the third party is input, the identification information of the owner, predetermined data, and authentication information of the third party are transmitted to the host computer. When receiving the identification information of the owner, predetermined data, and authentication information of the owner from the terminal, the host computer determines permission/rejection for/of reference to the personal information by the owner using the terminal, based on the received identification information of the owner, predetermined data, and authentication information of the owner.

Further, when receiving the identification information of the owner, predetermined data, and authentication information of the third party from the terminal, the host computer is able to determine permission/rejection for/of reference to the personal information by the third party using the terminal, based on the identification information of the owner, predetermined data, and authentication information of the third party.

This allows the third party permitted by the owner to refer to the personal information of the owner readily and more safely, while security for the owner personal information is being ensured.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing the structure of the system for personal information reference according to one embodiment of the present invention;

FIG. 2 is a block diagram showing the structure of the server of the system for personal information reference of FIG. 1;

FIG. 3 is a block diagram showing the structure of the user terminal in the system for personal information reference of FIG. 1;

FIG. 4 shows one example of a member table included in the database of FIG. 1;

FIG. 5 shows one example of a classification code table included in the database of FIG. 1;

FIG. 6 shows information recorded in the memory unit of FIG. 1;

FIG. 7 shows one example of an input screen of the user terminal of FIG. 1;

FIG. 8 is a flowchart showing the operation of the user terminal of FIG. 1;

FIG. 9 shows one example of the input screen of the user terminal in case of access from an owner using his own memory unit;

FIG. 10 shows one example of the input screen of the user terminal in case of access from a third party by borrowing the memory unit of the owner;

FIG. 11 shows one example of data transmitted from the user terminal to the server in case of access from the owner;

FIG. 12 shows one example of data transmitted from the user terminal to the server in case of access from the third party;

FIG. 13 is a flowchart showing the operation of the server of FIG. 1;

FIG. 14 is a flowchart showing the owner checking process of FIG. 13; and

FIG. 15 is a flowchart showing the third party checking process of FIG. 13.

### DESCRIPTION OF THE PREFERRED EMBODIMENTS

Description will, hereinafter, be made of a system for personal information reference according to one embodiment of the present invention. The system for personal information reference according to this embodiment is utilized through membership service.

Below is a description of a case in which the system for personal information reference is utilized for a membership health care service. A client himself (or herself) who receives this health care service, and health related staff such as a doctor, a radiographer, a nurse, a dietitian, a fitness instructor, a physical therapist, and a clinical psychotherapist who provide the health care service, register beforehand as members of a health care service business. The client himself or herself is provided with a memory unit described below as a membership card.

The health related staff registered as members may belong to the same medical institution or different medical institutions from one another.

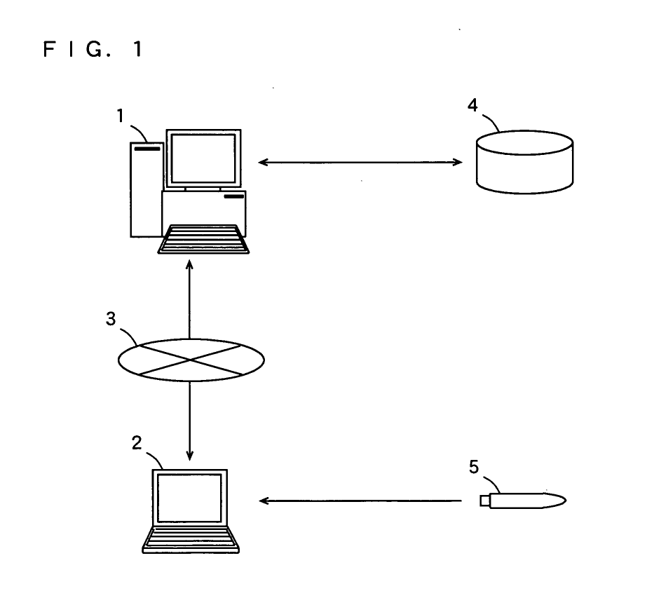

FIG. 1 is a schematic diagram showing the structure of the system for personal information reference according to one embodiment of the present invention.

The system for personal information reference of FIG. 1 includes a server 1, a user terminal 2, a database 4, and a memory unit 5. The server 1 and the user terminal 2 are interconnected via a network 3 which is the Internet or a public network.

The server 1 is a host computer located at a center of the health care service business. The server 1 has the database 4. The server 1 operates in accordance with a program for personal information reference described below. The database 4 stores heath-related information and the like of each member

The user terminal 2 is composed of a personal computer or the like, and is a terminal for use by a user. Users here include the member himself (or herself) and the health related staff such as a doctor.

The memory unit 5 is a portable recording medium composed of a flash memory or the like capable of recording and reading data. For example, a USB (Universal Serial Bus) key can be used as the memory unit 5. The USB key is a flash memory with a USB connector. Note that other recording mediums such as a memory card may be used as the portable recording medium.

In the following description, a member who accesses the database 4 using his (or her) own memory unit 5 (namely, an owner of the memory unit 5) is referred to as an owner, and a member who accesses the database 4 using other member's memory unit 5 (a health related staff such as a doctor, for example) is referred to as a third party.

For example, the owner lends his memory unit 5 to a doctor at a consultation room, after recognizing that the doctor to receive consultation is a member of the health care service business. This allows the doctor to access the database 4 as a third party.

Note that a health related staff such as a doctor may also be an owner when he (or her) accesses the database 4 using his (or her) own memory unit 5. In this case, the heath-related staff receives the service not as a doctor but as a member.

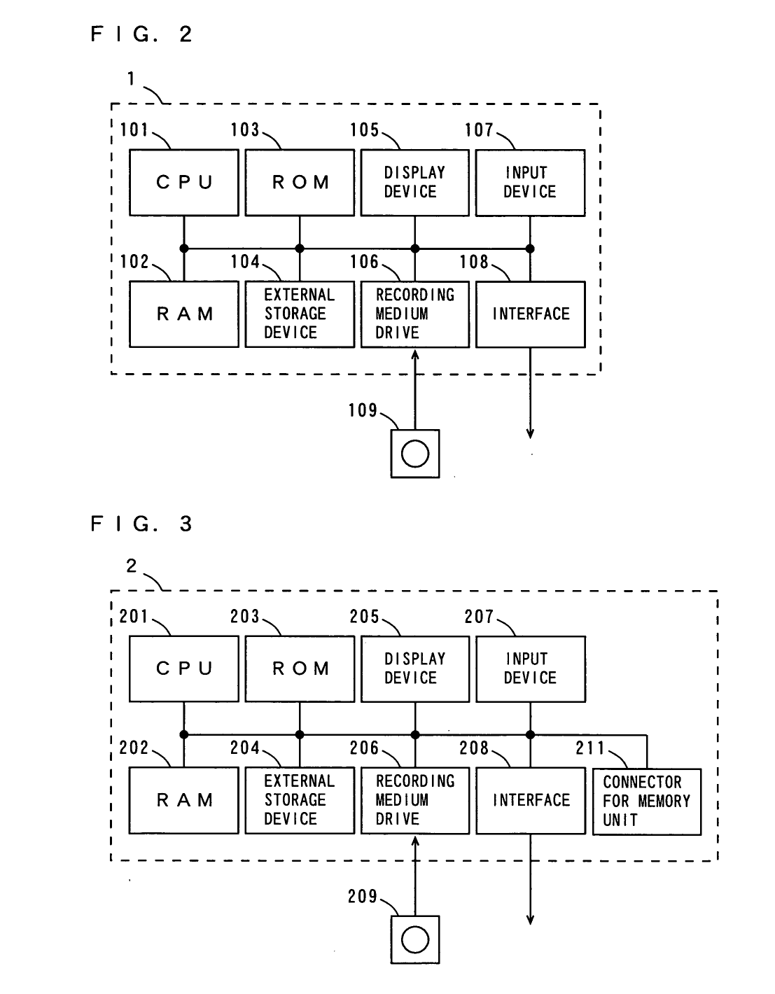

FIG. 2 is a block diagram showing the structure of the server 1 in the system for personal information reference of FIG. 1.

As shown in FIG. 2, the server 1 includes a CPU (Central Processing Unit) 101, a RAM (Random Access Memory) 102, a ROM (Read Only Memory) 103, an external storage device 104, a display device 105, a recording medium drive 106, an input device 107, and an interface 108.

The interface 108 is connected to the network 3. A system program is stored in the ROM 103. The recording medium drive 106 is composed of a CD-ROM (Compact Disc-Read Only Memory) drive, a floppy disc drive, or the like, and writes and reads data to and from a recording medium 109, which is a CD-ROM, a floppy disc, or the like. A program for personal information reference for the server 1 is stored in the recording medium drive 109.

The external storage device 104 is composed of a hard disc or the like, and stores the program for personal information reference which is read from the recording medium 109 via the recording medium drive 106. The database 4 is also constituted in the external storage device 104. The database 4 stores health related information including a plurality of items for each member, and also stores a member table and a classification code table described below. The health related information includes a variety of clinical data and the like obtained from physical examinations.

Additionally, the database 4 also stores access history information representing reference and update histories of health related information by a member or a third party. This access history information represents when, where, and who has accessed the health related information for each individual data unit.

The CPU 101 executes on the RAM 102 the program for personal information reference stored in the external storage device 104. The display device 105, which is composed of a CRT (Cathode Ray Tube), a liquid crystal display or the like, displays a variety of information. The input device 107 is composed of a keyboard, mouse, and the like.

Note that various types of recording mediums, such as a semiconductor memory, a ROM for example, or a hard disc may also be used as the recording medium 109 for recording the program for personal information reference. Further, the program for personal information reference may be downloaded into the external storage device 104 via the network 3 for execution on the RAM 102.

FIG. 3 is a block diagram showing the structure of the user terminal 2 in the system for personal information reference of FIG. 1.

As shown in FIG. 3, the user terminal includes a CPU 201, a RAM 202, a ROM 203, an external storage device 204, a display device 205, a recording medium drive 206, an input device 207, an interface 208, and a connector 211 for memory unit.

The interface 208 is connected to the network 3. The ROM 203 stores a system program. The recording medium drive 206 is composed of a CD-ROM drive, a floppy disc drive or the like, and reads and writes data from and to a recording medium 209, which is a CD-ROM, a floppy disc, or the like. The recording medium 209 stores a program for personal information reference for the user terminal 2.

The external storage device 204 is composed of a hard disc or the like, and stores the program for personal information reference read from the recording medium 209 via the recording medium drive 206.

The CPU 201 executes on the RAM 202 the program for personal information reference stored in the external storage device 204. The display device 205 is composed of a CRT, a liquid crystal display or the like, and displays an input screen described below and a variety of information. The input device 207 is composed of a keyboard, a mouse, and the like. The connector 211 for memory unit is connected with the memory unit 5 of FIG. 1.

Note that various types of recording mediums, such as a semiconductor memory, a ROM, for example, or a hard disc may be used as the recording medium 209 for recording the program for personal information reference. Further, the program for personal information may be downloaded into the external storage device 204 via the network 3 for execution on the RAM 202.

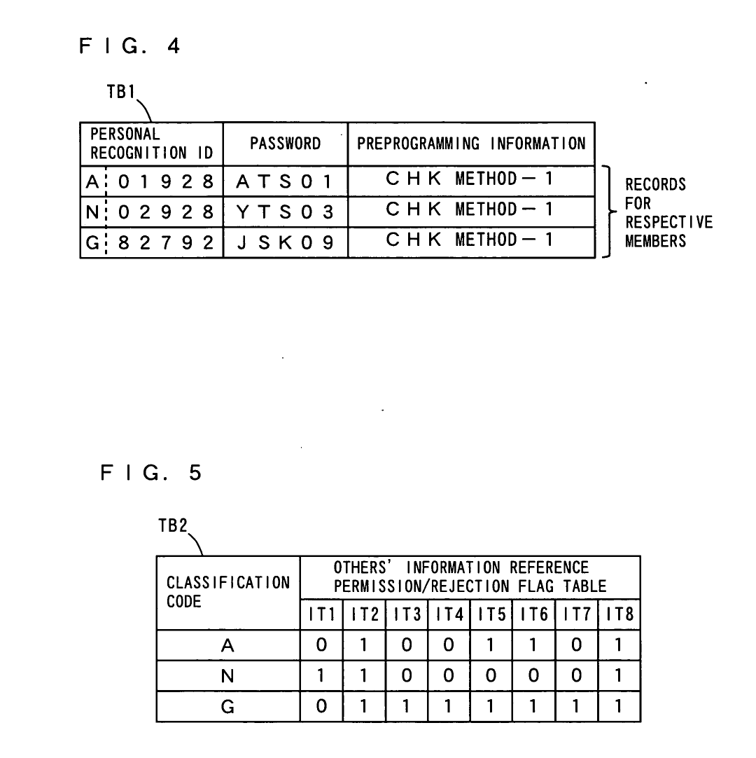

FIG. 4 shows one example of the member table included in the database 4 of FIG. 1.

As shown in FIG. 4, the member table TB 1 has a personal recognition ID field for storage of a personal recognition ID (identifier) of a member, a password field for storage of a password of a member, and a preprogramming information field for storage of preprogramming information described below. The personal recognition ID, password, and preprogramming information for each member are stored in the respective records of the member table TB1.

The personal recognition ID is identification information for identifying each member. A predetermined number of high order digits of the personal recognition ID is used as a classification code. In the example of FIG. 4, the highest digit of an alphabetical character of the personal recognition ID is the classification code, the rest of the five digits being a member registration number. As will now be described, each member can refer to some of the items among the health related information of other member, according to his (or her) allocated classification code as a third party. The password is authentication information set by the owner himself who has been given the personal recognition ID.

As an example, the classification code of a member having “N02928” as a personal recognition ID is “N”, and the member registration number is “02928”. Also, the classification code of a member having “G82792” as a personal recognition ID is “G”, the registration number being “82792”.

As an example, the password of the member having “N02928” as the personal recognition ID is “YTS03”, and “CHK method-1” is set as preprogramming information. Also, the password of the member having “G82792” as the personal recognition ID is “JSK09”, “CHK method-1” being set as preprogramming information.

The preprogramming information here represents a processing method, such as a program, calculation expression, or calculation method, for generating a specific security code by subjecting predetermined data to predetermined processing. For example, as such preprogramming information, a program is set which generates a security code by performing digit-checking for an owner's personal recognition ID. The preprogramming information “CHK method-1” shown in FIG. 4 is, for example, indicative of performing digit-checking for the five digits of a member registration number. Note that the preprogramming information also includes using the predetermined data without being processed as a security code. The security code generated based on the preprogramming information will, hereinafter, be referred to as program data.

Upon enrollment of a member, an administrator of the health care service business registers the member's personal recognition ID, password or preprogramming information in the member table TB1, using the input device 107 of FIG. 2. The administrator further modifies the member's personal recognition ID, password, or preprogramming information registered in the member table TB1 with the input device 107, in case of a modification request by the member. Furthermore, upon withdrawal of the member, the administrator removes the member's personal recognition ID, password, and preprogramming information from the member table TB1 using the input device 107. In case that the member has lost his memory unit 5, for example, the administrator modifies the member's personal recognition ID, password, or preprogramming information in the member table TB 1 using the input device 107.

FIG. 5 shows one example of the classification code table included in the database 4 of FIG. 1.

The classification code table TB2 of FIG. 5 has a classification code field for storage of classification codes and an others' information reference permission/rejection flag field for storage of others' information reference permission/rejection flags, each indicating whether or not the third party can refer to the other's information.

The classification code table TB2 of FIG. 5 stores whether or not reference can be made to the items IT1 to IT8. “1” indicates that reference can be made to the item, whereas “0” indicates that reference cannot be made to the item.

The owner can refer to all of the items of his own health related information using his memory unit 5. The third party, on the other hand, can refer to items set according to his classification code among the health related information of other member (the owner), using the memory unit 5 lent from the member (the owner).

In the example of FIG. 5, the member with the setting of “N” as a classification code can refer to the items IT1, IT2, IT8 of the other member's health related information as a third party. On the other hand, the member with the setting of “G” as a classification code can refer to the items IT2 to IT8 of the other member's health related information items as a third party.

A physician, for example, can refer to items related to internal medicine among the owner's health related information as a third party, whereas a radiographer can refer to items related to clinical data on radiography among the owner's health related information as a third party.

The administrator of the health care service business adds, modifies, or removes classification codes or others' information reference permission/rejection flags in the classification code table TB2, if necessary.

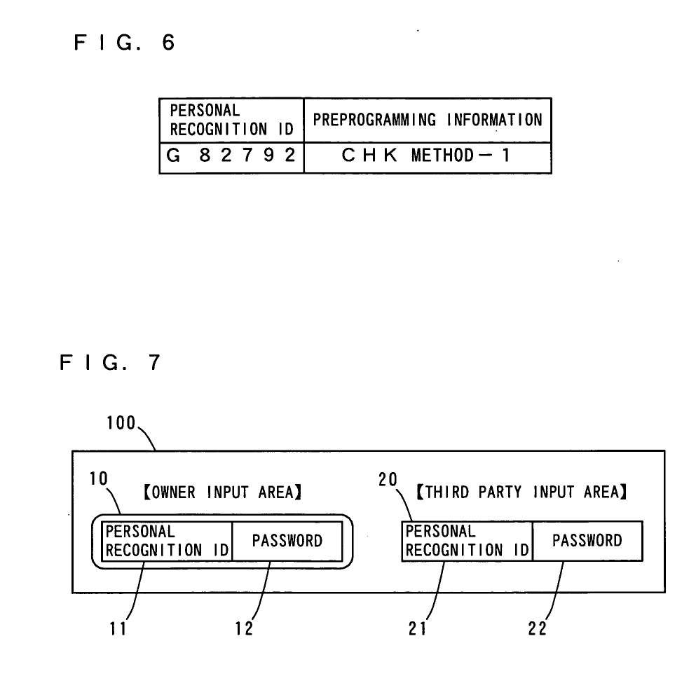

FIG. 6 shows information recorded in the memory unit 5 of FIG. 1. As shown in FIG. 6, the memory unit 5 stores an owner's personal recognition ID and preprogramming information.

FIG. 7 shows one example of the input screen on the user terminal 2 of FIG. 1. Connection of the memory unit 5 of FIG. 1 to the user terminal 2 provides display of the input screen as shown in FIG. 7 on the screen of the display device 205 of the user terminal 2.

The input screen 100 has an owner input area 10 and a third party input area 20. The owner input area 10 includes a personal recognition ID field 11 for displaying an owner's personal recognition ID and an owner password field 12 for receiving the owner's password entry. The third party input area 20 includes a personal recognition ID field 21 for receiving a third party's personal recognition ID entry and a password field 22 for receiving the third party's password entry.

Connection of the memory unit 5 to the user terminal 2 provides display of a personal recognition ID read from the memory unit 5 on the personal recognition ID field 11 of the owner input area 10. With the input device 207 of the user terminal 2, the owner's password, the third party's personal recognition ID, and the third party's password can be entered, respectively, in the password field 12 of the owner input area 10, the personal recognition ID field 21 and password field 22 of the third party input area 20.

Here, the personal recognition ID which is read by the user terminal 2 from the memory unit 5 to be displayed on the personal recognition ID field 11 of the owner input area 10, is referred to as an owner personal recognition ID. The password entered in the password field 12 of the owner input area 10 is referred to as an owner password. The personal recognition ID entered in the personal recognition ID field 21 of the third party input area 20 is referred to as a third party personal recognition ID, and the password entered in the password field 22 is referred to as a third party password.

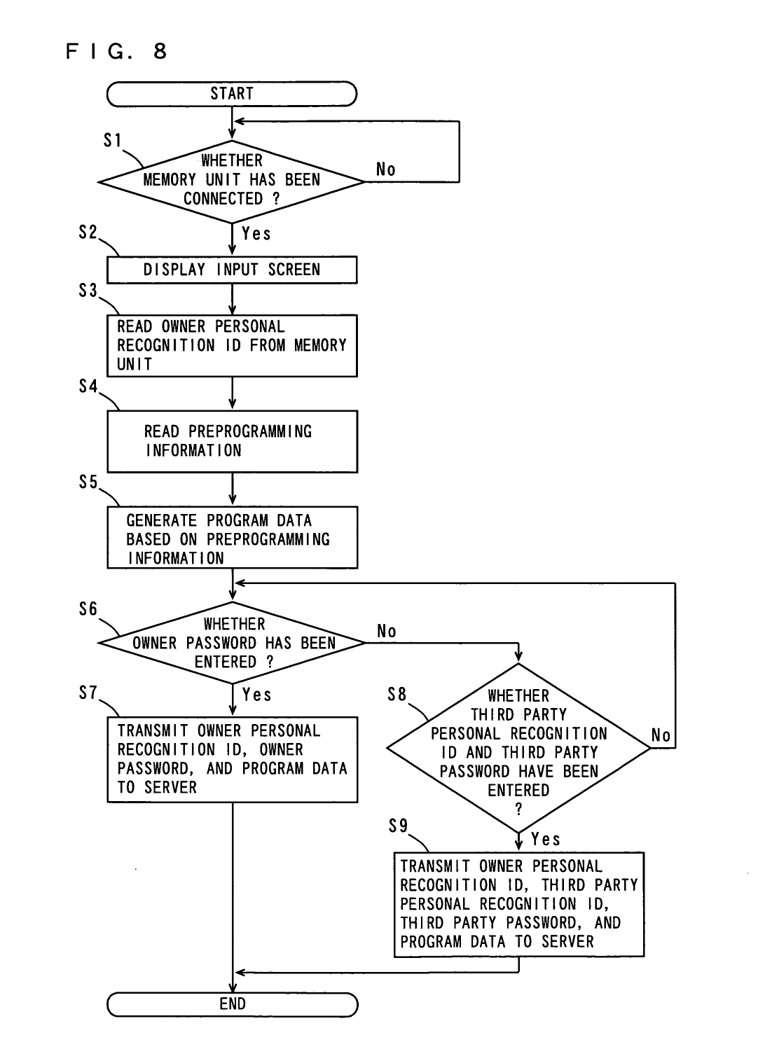

FIG. 8 is a flowchart showing the operation of the user terminal 2 of FIG. 1. The user terminal 2 operates in accordance with the program for personal information reference for the user terminal 2.

The user terminal 2 initially determines whether the memory unit 5 has been connected to the connector 211 for memory unit (Step S1). Where the memory unit 5 has been connected, the input screen 100 of FIG. 7 is displayed (Step S2).

The user terminal 2 subsequently reads an owner personal recognition ID from the memory unit 5 (Step S3). The user terminal 2 also reads preprogramming information from the memory unit 5 (Step S4). Then, the user terminal 2 generates program data based on the read preprogramming information (Step S5).

The user terminal 2 subsequently determines whether an owner password has been entered in the password field 12 of the owner input area 10 in the input screen 100 (Step S6). Where an owner password has been entered in the owner input area 10, the user terminal 2 transmits the owner personal recognition ID, owner password, and program data to the server 1 (Step S7).

Where an owner password has not been entered in the owner input area 10 at Step S6, the user terminal 2 determines whether or not a third party personal recognition ID and a third party password have been entered, respectively, in the personal recognition ID field 21 and the password field 22 of the third party input area 20 (Step S8).

Where the third party personal recognition ID and third party password have been entered in the third party input area 20, the user terminal 2 transmits the owner personal recognition ID, third party personal recognition ID, third party password, and program data to the server 1 (Step S8).

Where the third party personal recognition ID and third party password have not been entered in the third party input area 20 at Step S8, the user terminal 2 returns to Step S6 to wait for an owner password to be entered or a third party personal recognition ID and a third party password to be entered.

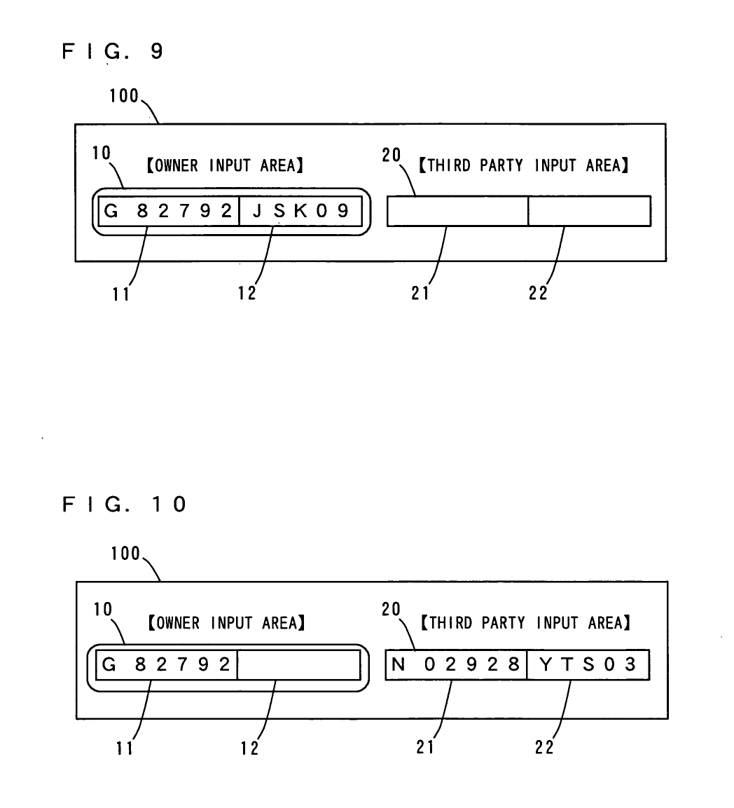

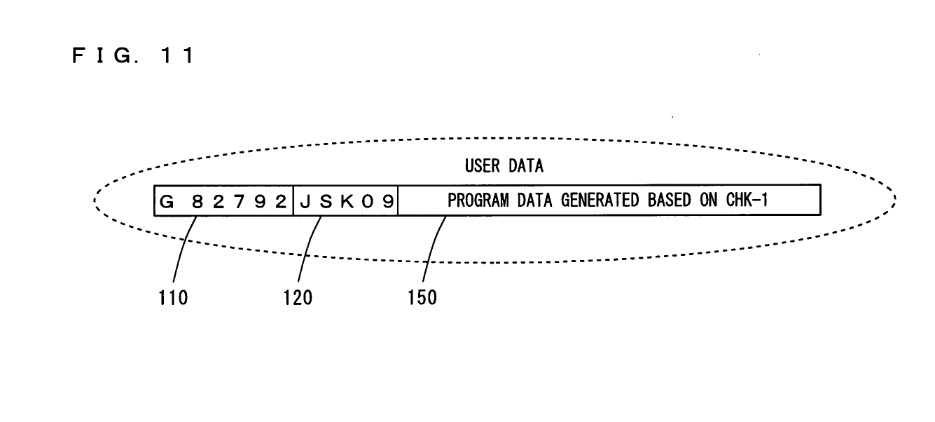

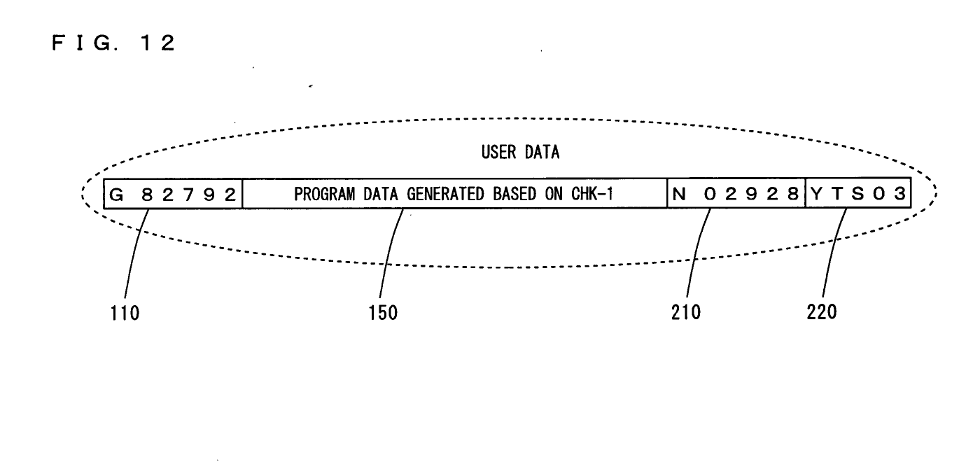

FIG. 9 shows one example of the input screen 100 of the user terminal 2 in the case of access from an owner using his own memory unit 5, and FIG. 10 shows one example of the input screen 100 of the user terminal 2 in the case of access from a third party by borrowing the owner's memory unit 5.

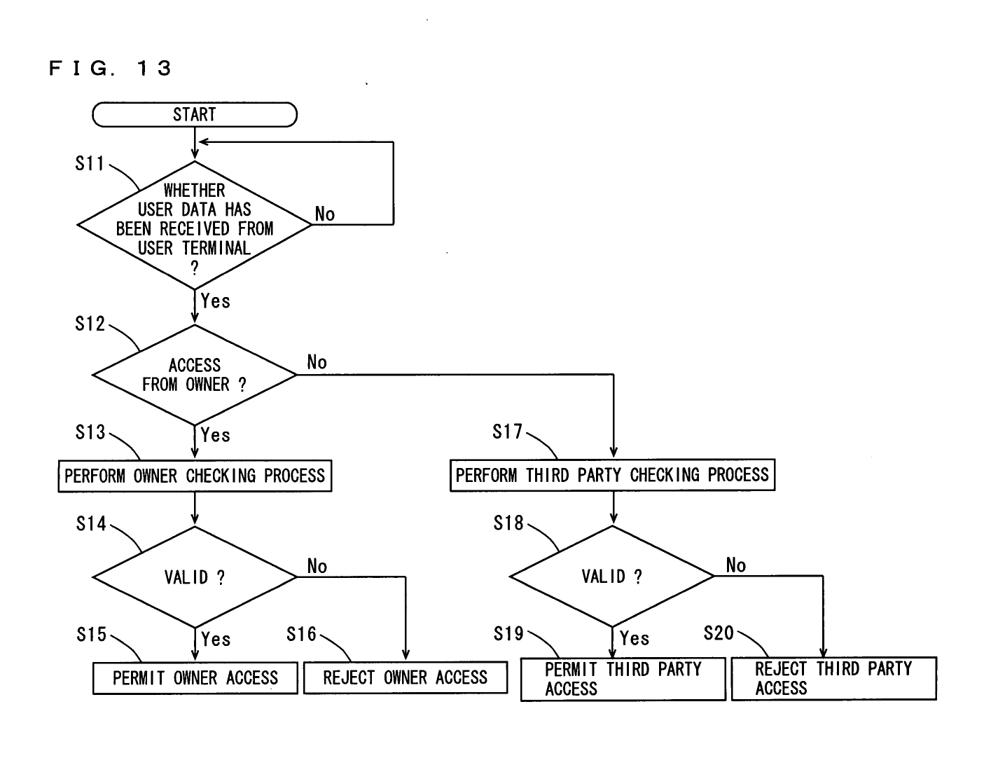

FIG. 11 shows one example of the data transmitted from the user terminal 2 to the server 1 in the case of access from the owner. FIG. 12 shows one example of the data transmitted from the user terminal 2 to the server 1 in the case of access from the third party. Here, the data transmitted from the user terminal 2 to the server 1 is referred to as user data.

Connection of the user terminal 2 to the memory unit 5 provides display of the input screen 100. The owner personal recognition ID which is read from the memory unit 5 is displayed on the personal recognition ID field 11 of the owner input area 10. In the example of FIG. 9, “G82792” is displayed as a personal recognition ID.

In the case of access from the owner, he enters his owner password in the password field 12 of the owner input area 10, as shown in FIG. 9. In the example of FIG. 9, “JSK09” is entered in the password field 12 as an owner password.

In this case, as shown in FIG. 11, the user data transmitted from the user terminal 2 to the server 1 includes an owner personal recognition ID 110, an owner password 120, and program data 150 generated based on the preprogramming information. In the example of FIG. 11, the user data includes “G82792” as the owner personal recognition ID 110, “JSK09” as the owner password 120, and the program data obtained based on the preprogramming information of “CHK-1” as the program data 150.

In the case of access from the third party, the third party leaves the password field 12 of the owner input area 10 blank, as shown in FIG. 10. The third party enters his third party personal recognition ID in the personal recognition ID field 21 of the third party input area 20, and enters his third party password in the password field 22 of the third party input area 20. In the example of FIG. 10, “N02928” is entered as the third party personal recognition ID in the personal recognition ID field 21 of the third party input area 20, and “YTS03” is entered as the third party password in the password field 22 of the third party input area 20.

In this case, as shown in FIG. 12, the user data transmitted from the user terminal 2 to the server 1 includes an owner personal recognition ID 110, program data 150 generated based on the preprogramming information, a third party personal recognition ID 210, and a third party password 220. In the example of FIG. 12, the user data includes “G82792” as the owner personal recognition ID 110, the program data obtained based on the preprogramming information “CHK-1” as the program data 150, “N02928” as the third party personal recognition ID 210, and “YTS03” as the third party password 220.

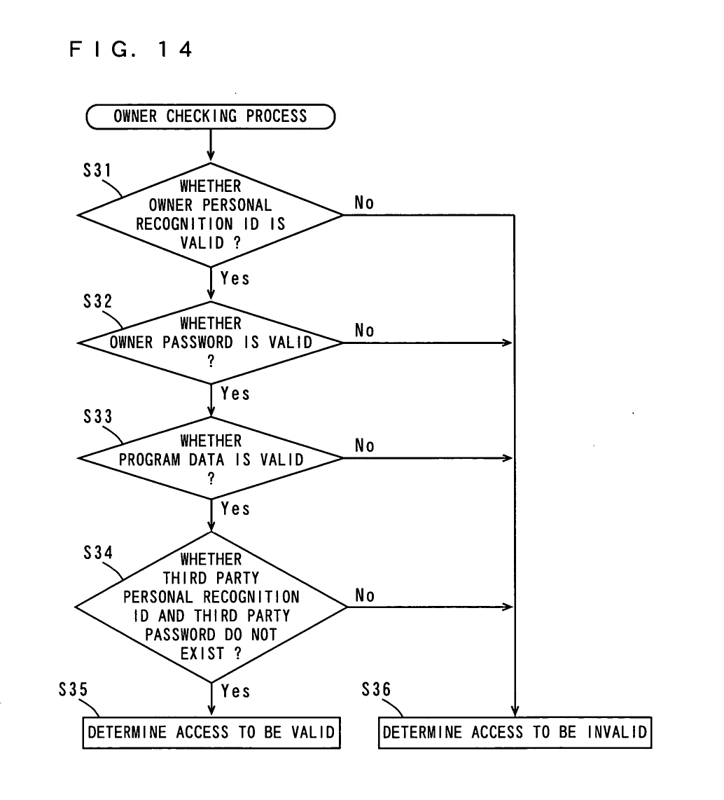

FIG. 13 is a flowchart showing the operation of the server 1 of FIG. 1. The server 1 operates in accordance with the program for personal information reference for the server 1.

The server 1 initially determines whether user data has been received from the user terminal 2 (Step S11). Where the user data has been received from the user terminal 2, the server 1 determines whether access is from an owner (Step S12). In this case, the server 1 determines that the access is from an owner when the user data includes an owner password, while determining that the access is from a third party when the user data includes a third party personal recognition ID and a third party password.

Where the access is from the owner, the server 1 performs an owner checking process described below (Step S13). Then, the server 1 determines whether a result of the owner checking process is valid (Step S14).

Where determining that the result of the owner checking process is valid, the server 1 permits access from the owner (Step S15). Where determining that the result of the owner checking process is not valid, the server 1 rejects access from the owner (Step S16).

Where determining that the access is not from an owner, the server 1 performs a third party checking process described below (Step S17). Then, the server 1 determines whether a result of the third party checking process is valid (Step S18).

Where determining that the result of the third party checking process is valid, the server 1 permits access from the third party (Step S19). Where determining that the result of the third party checking process is not valid, the server 1 rejects access from the third party (Step S20).

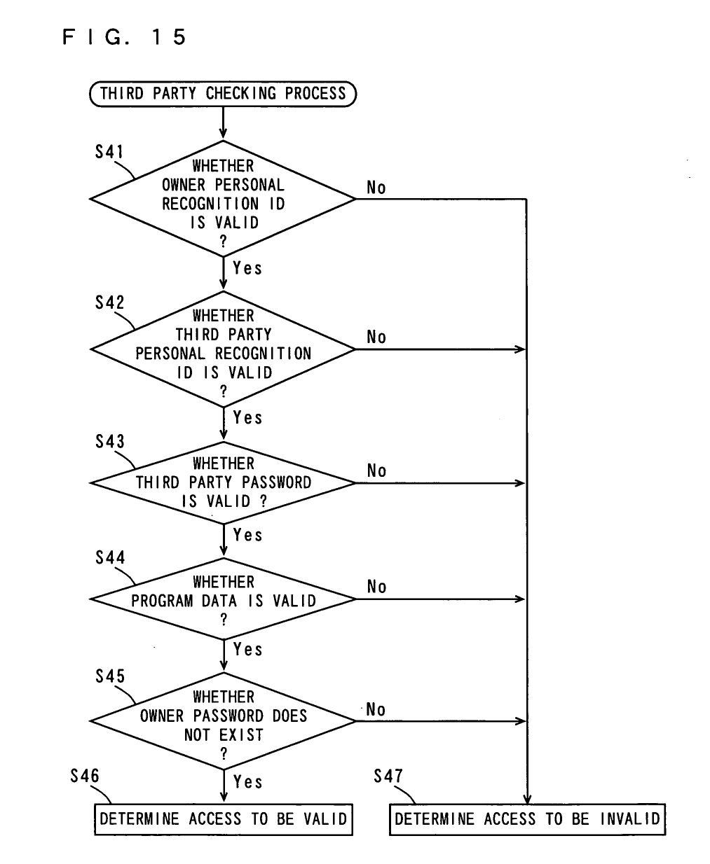

FIG. 14 is a flowchart showing the owner checking process of FIG. 13.

As shown in FIG. 14, the server 1 determines whether an owner personal recognition ID is valid based on the member table TB1 of FIG. 4 (Step S31).

Where determining that the owner personal recognition ID is valid, the server 1 determines whether an owner password is valid based on the member table TB1 of FIG. 4 (Step S32).

Where determining that the owner password is valid, the server 1 determines whether program data is valid (Step S33). In this case, the server 1 determines the validity of the program data by analyzing and verifying the program data based on the preprogramming information in the member table TB1 of FIG. 4.

Where determining that the program data is valid, the server 1 determines whether a third party personal recognition ID and a third party password do not exist (Step S34).

Where a third party personal recognition ID and a third party password do not exist, the server 1 determines the access from the owner to be valid (Step S35).

In this case, the owner is able to refer to all of the items of his own health related information stored in the database 4.

Where determining that the owner personal recognition ID is not valid at Step S31, where determining that the owner password is not valid at Step S32, where determining that the program data is not valid at Step S33, and also where a third party personal recognition ID or a third party password does exist at Step S34, the server 1 determines the access from the owner to be invalid (Step S36).

FIG. 15 is a flowchart showing the third party checking process of FIG. 13.

As shown in FIG. 15, the server 1 initially determines whether an owner personal recognition ID is valid based on the member table TB1 of FIG. 4 (Step S41).

Where determining that the owner personal recognition ID is valid, the server 1 determines whether a third party personal recognition ID is valid based on the member table TB1 of FIG. 4 (Step S42).

Where determining that the third party personal recognition ID is valid, the server 1 determines whether a third party password is valid based on the member table TB1 of FIG. 4 (Step S43).

Where determining that the third party password is valid, the server 1 determines whether program data is valid (Step S44). In this case, the server 1 determines the validity of the program data by analyzing and verifying the program data based on the preprogramming information in the member table TB1 of FIG. 4.

Where determining that the program data is valid, the server 1 determines whether an owner password does not exist (Step S45). Where an owner password does not exist, the server 1 determines the access from the third party to be valid (Step S46).

In this case, the third party is able to refer to items set according to his classification code among the owner's health related information stored in the database 4. A member having a personal recognition ID of “N02928”, for example, can refer to the items IT1, IT2, IT8 among the other member's health related information as a third party.

Where determining that the owner personal recognition ID is not valid at Step S41, where determining that the third party personal recognition ID is not valid at Step S42, where determining that the third party password is not valid at Step S43, where determining that the program data is not valid at Step S44, and also where determining that the owner password does exist at Step S45, the server 1 determines the access from the third party to be invalid (Step S47).

In the system for personal information reference according to the embodiment, each member can access the database 4 in the server 1 as an owner by connecting his own memory unit 5 to the user terminal 2, and entering his own password in the owner input area 10 of the input screen 100. This allows the member to refer to all of the items of his own health related information registered in the database 4.

Furthermore, each member can access the database 4 in the server 1 as a third party by connecting other member's memory unit 5 to the user terminal 2, and entering his own personal recognition ID and password in the third party input area 20 of the input screen 100. This allows the member to refer to items set according to the classification code among other member's health related information registered in the database 4.

Upon access to the health related information in the database 4 from each member or a third party, the server 1 creates and updates the access history information for each individual data unit for storage in the database 4.

This allows each member to refer to the access history information for each individual data unit with respect to his own health related information.

In this way, a specific third party can refer to set items of the other member's health related information, while security for the health related information of each member is being ensured. As a result, each member can readily receive appropriate instructions and advice from each health related staff based on the health related information, while his privacy security is being ensured.

In this case, any health related staff cannot refer to an owner's health related information as a third party without lending from the owner his memory unit 5. Consequently, it is possible for the third party with the owner's permission to readily and safely refer to specific items of the owner health related information.

In case that the member has lost his memory unit 5, access to the database 4 from other person who acquired the memory unit 5 can be readily prevented by modifying the preprogramming information stored in the member table TB1 in the database 4.

While a personal computer is used as the user terminal 2 in the embodiment, any other terminals, such as a portable telephone and a portable information terminal may be used as a user terminal 2 without limited to the one in the embodiment.

Further, while the preprogramming information is recorded in the memory unit 5 in the embodiment, predetermined data may be recorded therein instead of the preprogramming information. The predetermined data are, for example, codes, numerical values, or letters. In this case, the predetermined data are stored for each member also in the member table.

In the embodiment, the server 1 corresponds to a host computer or computer system; the user terminal 2 corresponds to a terminal or information processing apparatus; the memory unit 5 corresponds to a recording medium; the connector 211 for memory unit corresponds to a connector; the display device 205 corresponds to a display; the CPU 101 in the server 1 corresponds to a processing unit; and the database 4 in the external storage device 104 corresponds to a first storage and a second storage.

Further, the owner input area 10 corresponds to an owner input section, and the third party input area 20 corresponds to a third party input section. The personal recognition ID field 11 of the owner input area 10 corresponds to an owner identification information display area; the personal recognition ID field 21 of the third party input area 20 corresponds to a third party identification information input area; the password field 12 of the owner input area 10 corresponds to an owner authentication information input area; and the password field 22 of the third party input area 20 corresponds to a third party authentication information input area.

Moreover, the owner personal recognition ID corresponds to owner identification information; the third party personal recognition ID corresponds to third party identification information; the owner password corresponds to owner authentication information; and the third party password corresponds to third party authentication information. The preprogramming information corresponds to program information, and the health related information corresponds to personal information or information.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A system for personal information reference comprising:
a host computer that manages personal information;
a terminal capable of communicating with said host computer; and
a recording medium portable and connectable with said terminal, wherein
said recording medium records identification information for identifying an owner of the recording medium and program information indicative of a method for processing data,
said terminal transmits the identification information of said owner recorded in said recording medium and data generated based on said program information to said host computer when connected with said recording medium, and
said host computer determines permission/rejection for/of reference to said personal information from said terminal based on the identification data of said owner and said data received from said terminal.

2. The system for personal information reference according to claim 1, wherein
said terminal has an owner input section that receives input of authentication information for authenticating the owner of said recording medium,
when said terminal is connected with said recording medium, and the authentication information of said owner is input to said owner input section, said terminal transmits the identification information of said owner recorded in said recording medium and the data generated based on said program information along with the authentication information of said owner to said host computer, and
said host computer determines permission/rejection for/of reference to said personal information from said terminal based on the identification information of said owner, said data, and the authentication information of said owner received from said terminal.

3. The system for personal information reference according to claim 1, wherein
said host computer has a third party permitted to refer to said personal information registered,
said terminal has a third party input section that receives input of authentication information for authenticating said registered third party,
when said terminal is connected with said recording medium, and the authentication information of said third party is input to said third party input section, said terminal transmits the identification information of said owner recorded in said recording medium and the data generated based on said program information along with the authentication information of said third party to said host computer, and
said host computer determines permission/rejection for/of reference to said personal information from said terminal based on the identification information of said owner, said data, and the authentication information of said third party received from said terminal.

4. The system for personal information reference according to claim 3, wherein
said third party input section is further capable of receiving input of identification information for identifying said registered third party,
when said terminal is connected with said recording medium, and the authentication information of said third party and the identification information of said third party are input to said third party input section, said terminal transmits the identification information of said owner recorded in said recording medium and the data generated based on said program information along with the authentication information of said third party and the identification information of said third party to said host computer, and
said host computer determines permission/rejection for/of reference to said personal information from said terminal based on the identification information of said owner, said data, the authentication information of said third party, and the identification information of said third party received from said terminal.

5. The system for personal information reference according to claim 3, wherein
said host computer includes a preset item of personal information which can be referred to by said third party, and
said host computer permits reference to the preset item of personal information by said third party when determining that the identification information of said owner, said data, and the authentication information of said third party received from said terminal are valid.

6. A method for personal information reference using a host computer that manages personal information, a terminal capable of communicating with said host computer, and a recording medium portable and connectable with said terminal, said method comprising the steps of:
recording identification information for identifying an owner of the recording medium and program information indicative of a method for processing data into said recording medium;
transmitting, when said terminal is connected with said recording medium, the identification information of said owner recorded in said recording medium and data generated based on said program information to said host computer; and
determining by said host computer permission/rejection for/of reference to said personal information from said terminal based on the identification information of said owner and said data received from said terminal.

7. A program for personal information reference executable by a terminal capable of communicating with a host computer that manages personal information and connectable with a recording medium, said program allowing said terminal to execute the processes of:
reading from said recording medium identification information for identifying an owner of the recording medium and program information indicative of a method for processing data recorded in said recording medium;
receiving input of authentication information for authenticating the owner of said recording medium;
receiving input of authentication information for authenticating a third party different from the owner of said recording medium;
transmitting, when the authentication information of said owner is input, the identification information of said owner and the data generated based on said program information along with the authentication information of said owner to said host computer; and
transmitting, when the authentication information of said third party is input, the identification information of said owner and the data generated based on said program information along with the authentication information of said third party to said host computer.

8. A program for personal information reference executable by a host computer capable of communicating with a terminal, said program allowing said host computer to execute the processes of:
registering a member;
storing personal information of the member;
registering a third party who can refer to a preset item of said personal information;
permitting said terminal to refer to the personal information of said member when receiving identification information of said registered member and authentication information for authenticating said registered member from said terminal; and
permitting said terminal to refer to the preset item of the personal information of said member when receiving the identification information of said registered member and authentication information for authenticating said registered third party from said terminal.

9. An information processing apparatus connectable with a recording medium for recording information, comprising:
a connector connected with said recording medium; and
a display that displays an owner authentication information input area for inputting owner authentication information for authenticating an owner of said recording medium and a third party authentication information input area for inputting third party authentication information for authenticating a third party.

10. The information processing apparatus according to claim 9, wherein
said recording medium records identification information for identifying said owner, and
said display further has:
an owner identification information display area for displaying the identification information of the owner recorded in said recording medium; and
a third party identification information input area for inputting identification information for identifying said third party.

11. An information management method comprising the steps of:
storing information including one or more items into a first storage of a computer system;
registering a member permitted to refer to the information stored in said first storage and an item which can be referred to by the member into a second storage of said computer system; and
updating contents of the registration in said second storage by a processing unit of said computer system.

12. The information management method according to claim 11, wherein
said computer system is arranged to communicate with a terminal connectable with a recording medium that stores identification information,
said method further comprising the step of determining by said processing unit of said computer system permission/rejection for/of reference to the information stored in said first storage from said terminal based on the contents of registration in said second storage, when said computer system has received the identification information recorded in said recording medium from said terminal.

13. A system for personal information reference comprising:
a host computer that manages personal information;
a terminal capable of communicating with said host computer; and
a recording medium portable and connectable with said terminal, wherein
said recording medium records identification information for identifying an owner of the recording medium and predetermined data,
said terminal transmits the identification information of said owner and said predetermined data recorded in said recording medium to said host computer when connected with said recording medium, and
said host computer determines permission/rejection for/of reference to said personal information from said terminal based on the identification data of said owner and said predetermined data received from said terminal.

14. A method for personal information reference using a host computer that manages personal information, a terminal capable of communicating with said host computer, and a recording medium portable and connectable with said terminal, said method comprising the steps of:
recording identification information for identifying an owner of the recording medium and predetermined data into said recording medium;
transmitting, when said terminal is connected with said recording medium, the identification information of said owner and said predetermined data recorded in said recording medium to said host computer; and
determining with said host computer permission/rejection for/of reference to said personal information from said terminal based on the identification information of said owner and said predetermined data received from said terminal.

15. A program for personal information reference executable by a terminal capable of communicating with a host computer that manages personal information and connectable with a recording medium, said program allowing said terminal to execute the processes of:
reading from said recording medium identification information for identifying an owner of the recording medium and predetermined data recorded in said recording medium;
receiving input of authentication information for authenticating the owner of said recording medium;
receiving input of authentication information for authenticating a third party different from the owner of said recording medium;
transmitting, when the authentication information of said owner is input, the identification information of said owner and said predetermined data along with the authentication information of said owner to said host computer; and
transmitting, when the authentication information of said third party is input, the identification information of said owner and said predetermined data along with the authentication information of said third party to said host computer.
